(19) United States
(12) Patent Application Publication
(10) Pub. No.: US 2018/0259143 A1
(43) Pub. Date: Sep. 13, 2018

(54) METHODS, SYSTEMS AND APPARATUS FOR EMERGENCY LIGHTING

(71) Applicant: PHILIPS LIGHTING HOLDING B.V., Eindhoven (NL)

(72) Inventor: RAHUL SHIRA, CHICAGO, IL (US)

(21) Appl. No.: 15/537,100

(22) PCT Filed: Dec. 8, 2015
(86) PCT No.: PCT/IB2015/059434

§ 371 Date: Jun. 16, 2017

Related U.S. Application Data
(60) Provisional application No. 62/092,892, filed on Dec. 17, 2014.

(51) Int. Cl. F21S 9/02; H05B 37/02; H05B 33/08; H02J 9/06

(52) U.S. Cl. CPC F21S 9/022; H02J 9/065; H05B 33/0854; H05B 37/0227

(57) ABSTRACT

In various embodiments, on occurrence of a power up event, at least one lighting unit of a group of lighting units may be initiated in an emergency state in which the at least one lighting unit emits light having a fixed lighting property. A presence signal may be detected from one or more presence sensors associated with the group of lighting units. In response to detection of the presence signal, the at least one lighting unit may be transitioned from the emergency state to an occupancy lighting operational state in which the at least one lighting unit is selectively energized responsive to one or more presence signals from the one or more presence sensors.

### TECHNICAL FIELD

The present invention is directed generally to lighting control. More particularly, various inventive methods and apparatus disclosed herein relate to configuring lighting control environments for emergency situations.

### BACKGROUND

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

In so-called “occupancy sharing” lighting control environments, one or more light sources of a group of light sources may be selectively energized based on user presence (or absence). When no one is present for a sufficient period of time, all light sources may be de-energized (or otherwise switched to low power modes) to conserve energy. In some cases, one or more lighting controllers (e.g., integral with a luminaire or lighting unit, or standalone) may monitor one or more communication networks (e.g., Wi-Fi, ZigBee, coded light, etc.) for signals from one or more presence sensors (e.g., passive infrared or “PIR”, motion sensors, etc.). The one or more controllers may selectively operate one or more light sources based on receipt (or no receipt) of presence signals. In an emergency situation, however, only a subset of all light sources/presence sensors may receive power. Light sources and/or presence sensors not receiving power may no longer be able to provide presence signals. Interpreting the lack of presence signals as indicating that no one is present, the one or more lighting controllers may shut off light sources to conserve energy. In an emergency situation, this could pose a possible safety hazard and/or may violate one or more building codes. Thus, there is a need in the art to achieve occupancy sharing lighting control without compromising safety during emergencies and/or building code compliance.

### SUMMARY

The present disclosure is directed to inventive methods and apparatus for configuring lighting controllers to energize light sources to have one or more fixed lighting properties during potential emergency situations, and to automatically transition back to normal operation mode in response to various events. For example, one or more light sources may be designated as “emergency light sources.” In the event of an emergency (e.g., power provided by backup generator), those emergency light sources may be energized, e.g., by one or more controllers, at a relatively bright level until one or more events occurs, such as a person's presence being detected, or passage of a sufficient time interval (e.g., 90 minutes as required by some building codes). Upon occurrence of one or more events, the one or more controllers may transition into a “normal” operating mode in which they selectively illuminate the emergency light sources pursuant to an occupancy lighting scheme.

Generally, in one aspect, on occurrence of a power up event, at least one lighting unit of a group of lighting units may be initiated in an emergency state in which the at least one lighting unit emits light having a fixed lighting property. A presence signal may be detected from one or more presence sensors associated with the group of lighting units. In response to the detecting, the at least one lighting unit may be transitioned from the emergency state to an occupancy lighting operational state in which the at least one lighting unit is selectively energized responsive to one or more presence signals from the one or more presence sensors.

In some embodiments, the fixed lighting property may include a brightness or intensity level commensurate with task lighting. In some embodiments, the detecting may include detecting, from a presence sensor incorporated with the at least one lighting unit, the presence signal. In some embodiments, the detecting may include detecting, from a presence sensor incorporated with a lighting unit of the group of lighting units other than the at least one lighting unit, the presence signal.

In some embodiments, at least one of the one or more presence sensors may be powered solely with a non-emergency power source. In some embodiments, the power up event may include power being supplied from an emergency power source to the at least one lighting unit, and no power being supplied by the non-emergency power source.

In some embodiments, the at least one lighting unit may be powered with an emergency power source and bypassing the one or more presence sensors. In some embodiments, the at least one lighting unit may transmit, to one or more other lighting units of the group of lighting units, data indicative of the presence signal. In some embodiments, in response to the transmitted data, the one or more other lighting units may transition from the emergency state to the occupancy lighting operational state in which the one or more other lighting units are selectively energized responsive to one or more presence signals from the one or more presence sensors.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

“Occupancy sharing lighting control” as used herein refers to a lighting control scheme that may be used in environments such as offices or homes in which one or more light sources of a group of light sources may be selectively energized based on detected user occupancy. When no one is present for a sufficient period of time, all light sources may be de-energized (or otherwise switched to low power modes) to conserve energy. In some embodiments, one or more lighting controllers may monitor one or more communication networks (e.g., Wi-Fi, ZigBee, coded light, etc.) for signals from one or more presence sensors (e.g., passive infrared or “PIR”, motion sensors, etc.). The one or more controllers may selectively operate one or more light sources based on receipt (or no receipt) of presence signals. Examples of occupancy sharing lighting control environments will be described herein.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIGS. 1-4 illustrate example configurations of a lighting system, in accordance with various embodiments.

FIGS. 5a-d depict an example occupancy sharing lighting environment, in accordance with various embodiments.

FIG. 6 depicts an example method 600 of transitioning from an emergency situation to occupancy sharing lighting, in accordance with various embodiments.

### DETAILED DESCRIPTION

In occupancy sharing lighting control environments, one or more light sources of a group of light sources may be selectively energized based on user presence detected by one or more presence sensors. When no one is present for a sufficient period of time, all light sources may be de-energized (or otherwise switched to low power modes) to conserve energy. In an emergency situation, however, only a subset of all light sources and/or presence sensors may receive power. One or more controllers may interpret a lack of presence signals to mean that no one is present, and may shut off light sources to conserve energy. In an emergency situation, this could pose a possible safety hazard and may violate one or more building codes. Thus, there is a need in the art to achieve occupancy sharing lighting control without compromising safety during emergencies and/or building code compliance. More generally, Applicants have recognized and appreciated that it would be beneficial to provide an occupancy sharing lighting system that is configured in emergency situations to reliably provide light, at least until one or more events indicative of the end of the emergency situation is detected.

In view of the foregoing, various embodiments and implementations of the present invention are directed to initiating, on occurrence of a power up event, at least one lighting unit of a group of lighting units in an emergency state in which the at least one lighting unit emits light having a fixed lighting property (e.g., 100% brightness, task lighting, etc.). On detection of a presence signal from one or more presence sensors associated with the group of lighting units (or in some cases after passage of a sufficient time interval, such as 90 minutes), the at least one lighting unit may be transitioned from the emergency state to another state, such as an occupancy lighting operational state in which the at least one lighting unit is selectively energized responsive to one or more presence signals from the one or more presence sensors.

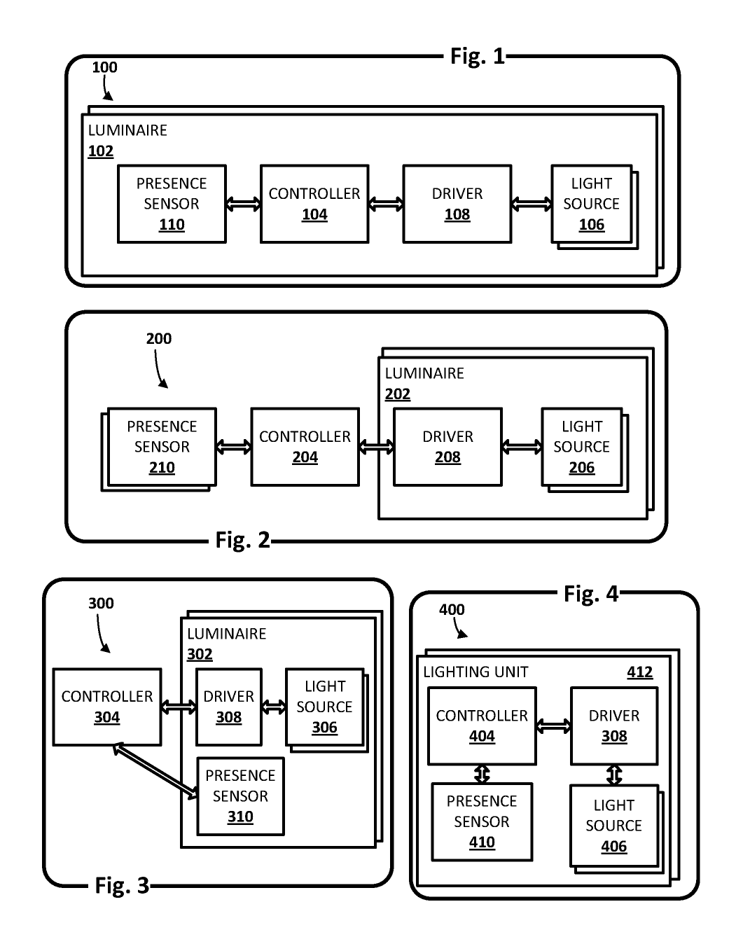

FIGS. 1-4 depict three non-limiting variations of occupancy sharing lighting systems that may be configured with selected aspects of the present disclosure. In the embodiment FIG. 1, occupancy sharing lighting system 100 may include one or more luminaires 102. At least some of the luminaires 102 may include a controller 104 that is operably coupled with one or more light sources 106 via one or more drivers 108. In various embodiments, light sources 106 (and other light sources described herein) may take various forms, such as LED, incandescent, fluorescent, halogen, and so forth. In various embodiments, drivers 108 may in some embodiments take the form of ballasts, e.g., configured to drive one or more LEDs. In some embodiments, driver 108 may be omitted.

In various embodiments, controller 104 may receive one or more signals, e.g., from one or more presence sensors 110, and may selectively illuminate one or more light sources 106 based on those signals, e.g., by operating driver 108. In various embodiments, presence sensor 110 (and other presence sensors described herein) may utilize various technologies to detect and generate a signal representative of user presence, including but not limited to passive infrared (“PIR”), microwave, ultrasonic, tomographic, video motion detection, and so forth. Components within luminaire 102 such as presence sensor 110, controller 104, driver 108 and/or light source 106 may be communicably coupled with each other using various wired or wireless technologies, such as one or more buses.

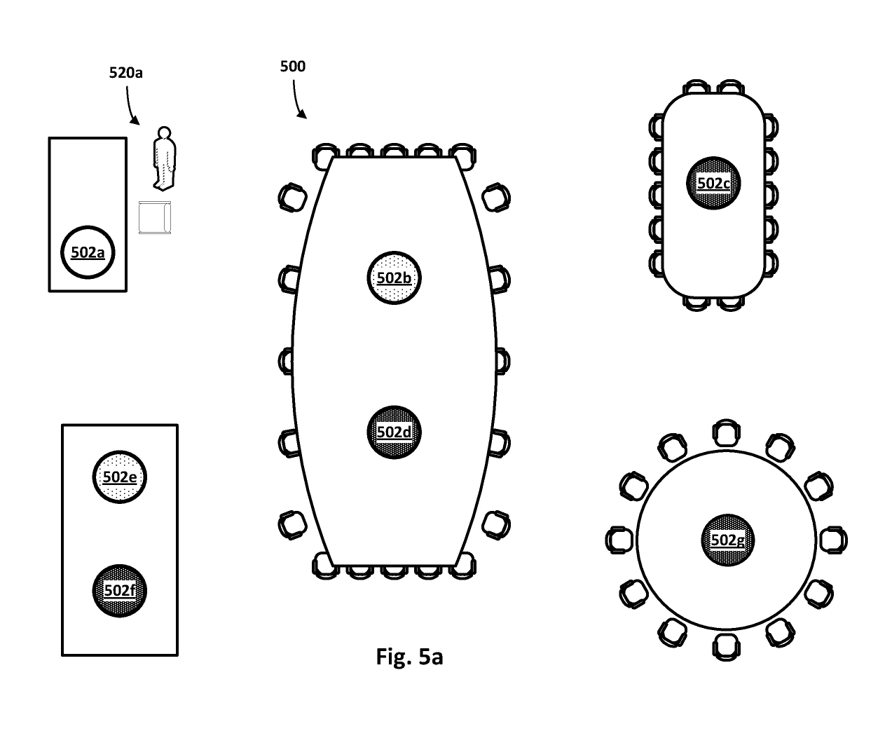

In the embodiment of FIG. 2, occupancy sharing lighting system 200 includes components similar to occupancy sharing lighting system 100 of FIG. 1. For example, one or more luminaires 202 may include one or more light sources 206 operated by one or more drivers 208. In this example, however, controller 204 is not integral with luminaire 202, but instead is a standalone controller, such as a lighting system bridge, and is communicably coupled with driver 208, e.g., using various wired or wireless technologies, such as Wi-Fi, ad hoc networks such as ZigBee, radio frequency identification (“RFID”), coded light, BlueTooth, and so forth. Controller 204 likewise may be communicably coupled with one or more presence sensors 210, e.g., using the same technology as controller 204 uses to communicate with driver 208, or different technology. In this example, the one or more presence sensors 210 are standalone, rather than being an integral part of luminaire 202. In some variations, luminaire 202 may also include one or more internal controllers (not depicted) that are communicably coupled between standalone controller 204 and driver 208. In other embodiments, all three of controller 204, driver 208 and light source 206 may be integral with luminaire 202, and controller 204 may communicate with one or more external presence sensors 210 using one or more of the aforementioned communication technologies.

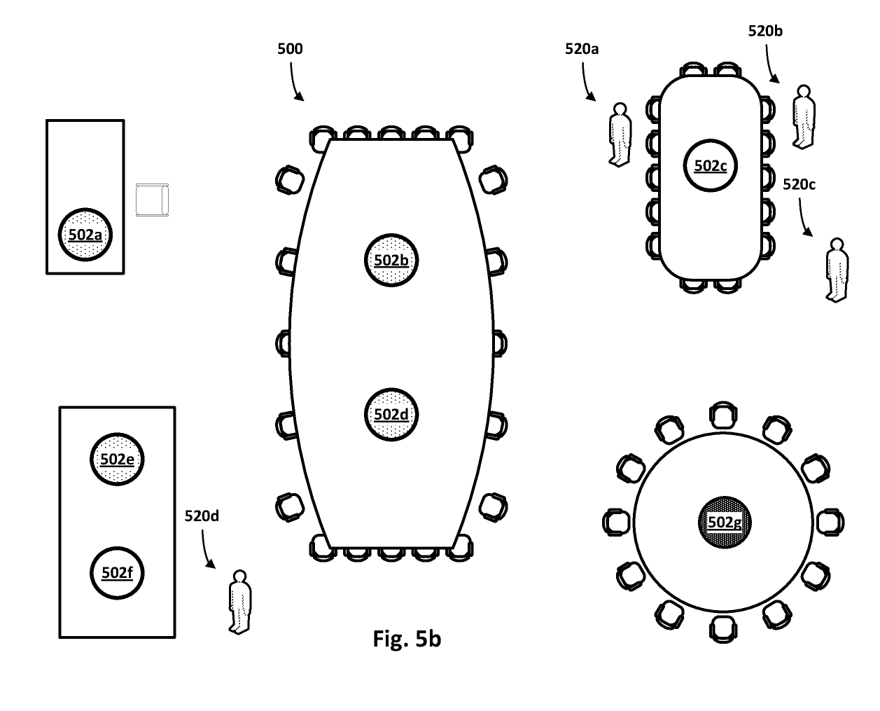

In the embodiment of FIG. 3, occupancy sharing lighting system 300 includes one or more luminaires 302 that include one or more integral light sources 306, one or more corresponding drivers 308, and one or more integral presence sensors 310. Like controller 204 in FIG. 2, a standalone controller 304 is communicably coupled with driver 308 and/or presence sensor 310 using one or more of the aforementioned communication technologies.

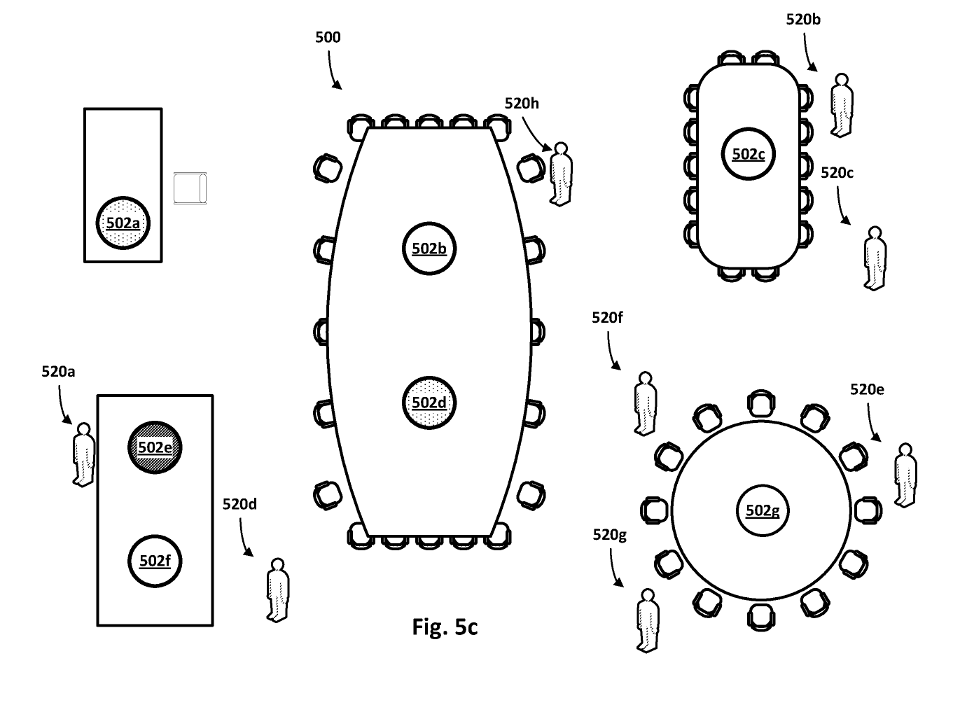

In the embodiment of FIG. 4, a “smart” lighting unit 412 is provided that includes a controller 404, a driver 408, one or more light sources 406 (typically but not necessarily LEDs) and one or more presence sensors 410. In this example, lighting unit 412 may be installed into a “dumb” luminaire (not depicted), which may avoid the need to replace existing luminaires with the so-called “smart” luminaires 102, 202 and 302 depicted in FIGS. 1-3. Any combination of the various configurations depicted in FIGS. 1-4 may be employed in a single occupancy sharing lighting system.

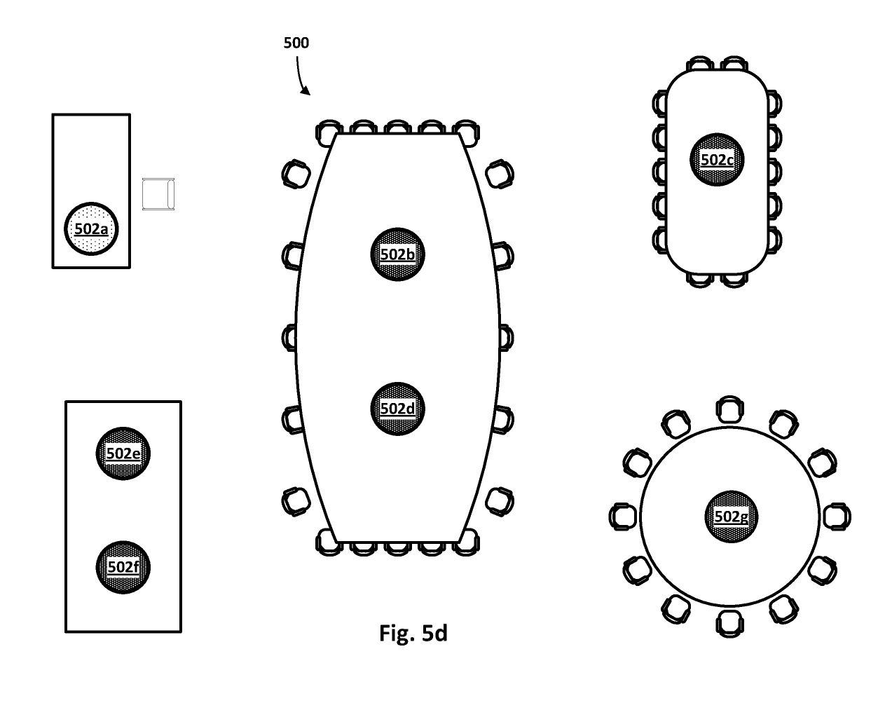

FIGS. 5a-d depict one example of occupancy sharing lighting control in operation. In some embodiments, an occupancy sharing luminaire (or “smart” lighting unit installed in a “dumb” luminaire) may transition to a fully-energized state in which it provides task lighting on satisfaction of some criterion, such as user presence being detected nearby. After a predetermined time interval has passed without receiving any presence signals (or itself detecting presence), the luminaire may transition to a partially energized state in which it provides background illumination. After passage of another predetermined time interval without detecting user presence or receiving any presence signals, the luminaire may transition to a de-energized state (or a low energy state) in which it provides no lighting (or very little lighting).

In FIG. 5a, seven luminaires 502a-g configured with selected aspects of the present disclosure are distributed throughout a workplace. Luminaire 502a is on a desk at top left, luminaires 502b and 502d are on a center conference table, luminaire 502c is on a smaller conference table at top right, luminaire 502g is on the middle of a circular conference table at bottom right, and luminaires 502e and 502f are on a workplace at bottom left. Occupancy sharing is depicted in FIGS. 5a-d as being controlled by luminaires 502a-g, which could be similar to luminaire 102 of FIG. 1, luminaire 202 of FIG. 2, and/or luminaire 302 of FIG. 3. However, this is not meant to be limiting. Occupancy sharing may operate the same if instead of “smart” luminaires,” “dumb” luminaires with “smart” lighting units (e.g., 412 in FIG. 4) installed are used instead (or in addition).

In FIG. 5a, a first person 520a has entered the environment and is near the top left desk, and thus near luminaire 502a. A presence sensor (not depicted), which may be integral with luminaire 502a or standalone, may detect the presence of first person 520a, and may notify luminaires 502a-g. Based on that notification, luminaire 502a is selectively energized to emit a light having on or more selected characteristics, such as full illumination (e.g., task lighting, shown with white fill). Other nearby luminaires 502b and 502e are also energized, though at a lower level to provide background illumination (shown with intermediate fill). In some embodiments, remaining luminaires 502c, 502d, 502f and 502g may remain de-energized (shown with dark fill) because one or more controllers may determine that the presence of user 520a is not sufficiently nearby to warrant illumination. In other embodiments, all luminaires may be at least partially energized when presence is detected anywhere within the occupancy sharing lighting control environment.

In FIG. 5b, first person 520a has moved to the small conference table at top right to have a meeting with persons 520b and 520c. Their presence is detected by one or more presence detectors (incorporated in luminaire 502c or standalone), which notifies all luminaires 502a-g. In response, luminaire 502c is selectively energized to provide full illumination for the meeting between persons 520a-c. Luminaire 502b has determined that it is sufficiently near the presence of persons 520a-c that it should continue to provide background illumination. Meanwhile, a fourth person 520d has arrived and is working at the bottom left work place. The presence of fourth person 520d is detected by one or more presence sensors, which in turn notify luminaires 502a-g. In response, luminaire 502f is energized to provide full illumination, and luminaire 502e is energized to provide background illumination. Luminaire 502d determines that it is near enough fourth person 520d to be partially energized to provide background illumination. Luminaire 502g remains dark. With no one present nearby, luminaire 502a may emit background lighting for some predetermined time interval before it shuts off.

In FIG. 5c, first person 520a has moved to the workplace at bottom left to join fourth person 520d. This presence is detected by one or more presence sensors, which notify luminaires 502a-g. In response, both luminaires 502e and 502d, which are at the workplace, are fully energized. Nearby luminaires 502a and 502b are partially energized to provide background illumination. Another meeting is occurring at the round table at bottom right, this time between persons 520e-g. In response, luminaire 502g is fully energized to provide task lighting. Persons 520b-c remain at the top right conference table, so luminaire 502c remains fully energized to provide task lighting. A new person 520h is working near the top of the large center conference table, and so luminaire 502b is fully energized to provide task lighting.

FIG. 5d depicts the environment shortly after everyone has left for the day. The only luminaire that remains partially energized is luminaire 502a, perhaps because it is near an exit recently used by the last occupant. Luminaire 502a may remain partially energized for some predetermined time interval, after which, unless it receives a presence signal, it may de-energize completely.

In some embodiments, if any presence sensor of an occupancy sharing lighting control system such as that depicted in FIGS. 5a-d detects a presence, then all luminaires may remain energized to some extent. Those luminaires that detect presence nearby (e.g., via integral presence sensors or from signals received from nearby presence sensors) may remain highly energized, e.g., emitting task lighting. Other luminaires that do not detect presence nearby may be energized to a lesser degree to provide background lighting.

As noted in the background, building codes may require that lighting be provided in emergency situations such as power outages. Emergency lighting units may be battery powered (e.g., with rechargeable backup batteries to supplement “regular” power, e.g., mains) or may be coupled with one or more emergency generators. While some building codes simply permit emergency lights to be always on, some building codes may permit emergency lights to be turned off in response to various events. For example, some building codes may permit emergency lights to be turned off after some predetermined time interval, or based on a sensor signal (e.g., a presence signal).

In occupancy sharing lighting control environments like the one depicted in FIGS. 5a-d, each luminaire (or smart lighting unit) may constantly scan a lighting control network (e.g., ZigBee) for “occupancy messages” (e.g., a presence signal) from presence sensors that are standalone or integral with other luminaires (or other smart lighting units). If no occupancy messages are received by a luminaire for a predetermined time interval, that luminaire may interpret that to mean no one is present, and may turn off to save power. However, in an emergency situation, it may be the case that one or more presence sensors are not receiving power, which means the luminaire may not receive occupancy messages, and may shut off, in spite of the fact that people are present.

Accordingly, in various embodiments, on occurrence of a power up event, at least one lighting unit or luminaire of a group of lighting units/luminaires may be initiated in a first state, such as an emergency state in which the at least one lighting unit/luminaire emits light having a fixed lighting property (e.g., task lighting). Until a presence is detected by a presence sensor (e.g., integral with the lighting unit or luminaire, with another lighting unit or luminaire, or standalone), that lighting unit or luminaire may continue to emit task lighting. On detection of a presence signal from one or more presence sensors associated with the group of lighting units, the lighting unit or luminaire may transition from the first state to a second state, such as an occupancy lighting operational state in which the at least one lighting unit is selectively energized responsive to one or more presence signals from the one or more presence sensors. This method ensures that the lighting unit or luminaire will not “leave people in the dark.” It also ensures that while people are present, light will continue to be provided, but once people are actually no longer present, light will cease being supplied, saving power. This technique may also relieve lighting maintenance personnel from having to configure certain luminaires or lighting units as dedicated emergency luminaires or lighting units; all luminaires or lighting units may provide this safety feature.

In some embodiments, when in the emergency state, luminaires and/or lighting units configured with selected aspects of the present disclosure may emit light with a brightness or intensity level commensurate with task lighting. In other embodiments, luminaires and/or lighting units configured with selected aspects of the present disclosure may emit light with other characteristics, such as extreme brightness, intermittent flashing or other dynamic light patterns, different hues (e.g., colors that may be more suitable for use in smoky environments), and so forth.

In some embodiments, at least one of the one or more presence sensors (standalone or integral with a luminaire or lighting unit) may be powered solely with a non-emergency power source, such as AC mains. In an emergency event, no power may be supplied by the non-emergency power source. Power may instead be supplied from an emergency power source (e.g., an on-site generator) to one or more other luminaires or lighting units, e.g., bypassing one or more presence sensors. In such instances, the powered luminaires and/or lighting units may remain energized until regular power is restored. At that point one or more presence sensors may be restored, and thereafter may detect user presence.

In some embodiments where a luminaire or lighting unit has an integral presence sensor, the luminaire or lighting unit may transmit, e.g., to one or more other lighting units of a group of lighting units, data indicative of the presence signal. The one or more other lighting units may, in response to the data indicative of the presence signal, transition from an emergency state to, for instance, an occupancy lighting operational state in which the one or more other lighting units are selectively energized responsive to one or more presence signals from the one or more presence sensors.

In various embodiments, a luminaire and/or lighting unit may emit various levels of light based on the amount of daylight available. For example, while not shown in FIGS. 5a-d, in various embodiments, luminaires and/or lighting units may perform “daylight harvesting,” in which they adjust their light output based on available daylight. For example, when daylight is at its brightest, a lighting unit emitting background lighting may emit a lower level of light than it would in the evening.

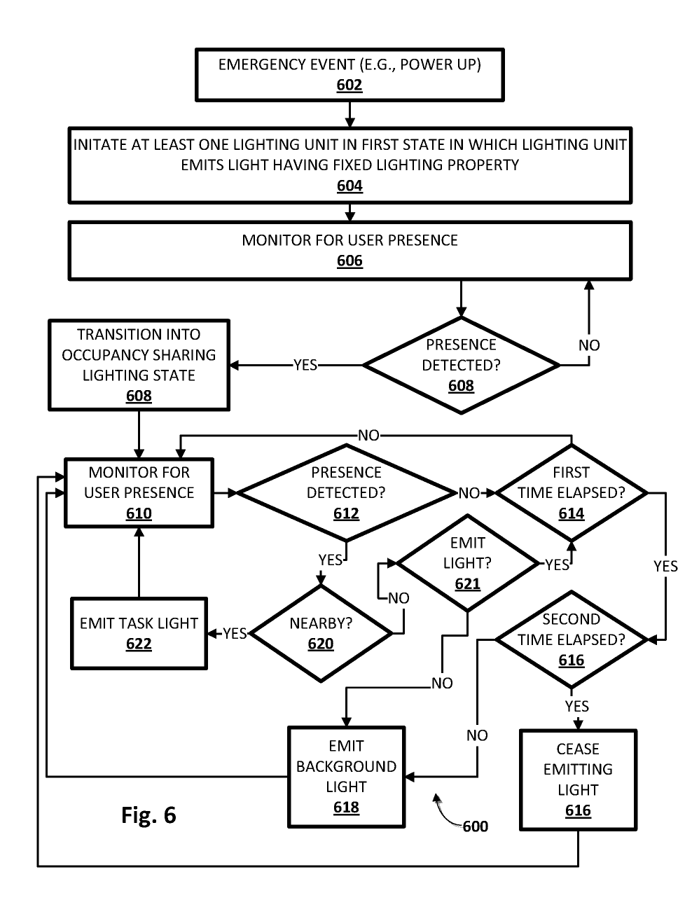

FIG. 6 depicts an example process 600 of transitioning from an emergency situation to occupancy sharing lighting, in accordance with various embodiments. One or more operations of process 600 may be performed variously by luminaires, “smart” lighting units, and or lighting controllers such as lighting system bridges. However, for the sake of brevity, in this example, the operations will be explained as being performed by a lighting unit.

At block 602, occurrence of an emergency event (e.g., power up with emergency generator, circuit breaker trip, etc.) may occur, setting process 600 in motion. At block 604, the lighting unit may be initiated in a first state, e.g., an emergency state, in which the lighting unit emits light having a fixed lighting property. In many embodiments, the emitted light may be relatively bright, such as task lighting. In some embodiments, features such as daylight harvesting may be disabled in an emergency state, though this is not required.

At block 606, the lighting unit may monitor for user presence (or in some embodiments, alternatively, passage of a sufficient time interval such as 90 minutes). As explained above, the lighting unit may monitor an internal, integral presence sensor, a presence sensor integral in another lighting unit or luminaire, or a standalone presence sensor. In any case, upon detection of user presence at block 608, the lighting unit may transition into an occupancy sharing lighting state. In the occupancy sharing lighting state, the lighting unit in some embodiments may begin by emitting task lighting, background lighting, no light at all, or light at some other level. In some embodiments, even in an emergency state, the lighting unit may already be configured to transmit signals to other lighting units/luminaires when it detects user presence, just as it would during normal occupancy sharing operation. It may only act “differently” in the emergency state insofar as its own emitted light stays the same until one or more events occur, such as detection of user presence and/or passage of a sufficient time interval, such as 90 minutes.

At block 610, the lighting unit may once again monitor for user presence, similar to block 606. At block 612, if the lighting unit does not detect user presence, then at block 614 it may determine whether a first predetermined time interval has elapsed since user presence was detected. For instance the lighting unit may be configured to emit task lighting for the first time interval, but to emit less light afterwards to conserve energy. If at block 614 the answer is no, then the lighting unit may continue to monitor for user presence at block 610. If at block 614 is answer is yes, however, then process 600 may proceed to block 616.

At block 616, the lighting unit may determine whether a second predetermined time interval has passed. For instance, in some embodiments, a lighting unit may be configured to emit task lighting for a first time interval after user presence is detected, the emit background lighting for a second time interval. If the second time interval passes before user presence is detected again, the lighting unit may then shut off. For instance, in FIG. 6 at block 616, if the second time interval has lapsed, then the lighting unit may cease emitting light and go back to block 610. If, at block 616, the second time interval has not passed, then the lighting unit may emit (or continue to emit) background light at block 618. Process 600 may proceed back to block 610, at which the lighting unit may monitor for user presence.

Back at block 612, if user presence is detected, then process may proceed to block 620. At this point in some embodiments, the lighting unit may start (or reset and start) a timer that may be compared to the time intervals discussed with regard to blocks 614 and 616. At block 620, if the presence was detected nearby, e.g., by a presence sensor integral with the lighting unit or by a nearby presence sensor (integral with another lighting unit or luminaire, or standalone), then the lighting unit may emit task lighting at block 622, after which it may continue to monitor for user presence. If, at block 620, the detected presence is not determined to be nearby (e.g., by a presence sensor in a different room), process 600 may proceed to block 621. At block 621, it may be determined whether the lighting unit is emitting any light at all (e.g., full task lighting or background lighting). If the answer is no, then the lighting unit may emit background light at block 618. If the answer is yes, then method 600 may proceed to block 614.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A lighting control method, comprising:
initiating, on occurrence of a power up event, at least one lighting unit of a group of lighting units in an emergency state in which the at least one lighting unit emits light having a fixed lighting property;
detecting a presence signal from one or more presence sensors associated with the group of lighting units; and
transitioning, in response to the detecting, the at least one lighting unit from the emergency state to an occupancy lighting operational state in which the at least one lighting unit is selectively energized responsive to one or more presence signals from the one or more presence sensors.

2. The lighting control method of claim 1, wherein the fixed lighting property comprises a brightness or intensity level commensurate with task lighting.

3. The lighting control method of claim 1, wherein the detecting comprises detecting, from a presence sensor incorporated with the at least one lighting unit, the presence signal.

4. The lighting control method of claim 1, wherein the detecting comprises detecting, from a presence sensor incorporated with a lighting unit of the group of lighting units other than the at least one lighting unit, the presence signal.

5. The lighting control method of claim 1, further comprising powering at least one of the one or more presence sensors solely with a non-emergency power source.

6. The lighting control method of claim 5, wherein the power up event comprises power being supplied from an emergency power source to the at least one lighting unit, and no power being supplied by the non-emergency power source.

7. The lighting control method of claim 1, further comprising powering the at least one lighting unit with an emergency power source and bypassing the one or more presence sensors.

8. The lighting control method of claim 1, further comprising transmitting, by the at least one lighting unit to one or more other lighting units of the group of lighting units, data indicative of the presence signal.

9. The lighting-control method of claim 8, further comprising transitioning, in response to the transmitted data, the one or more other lighting units from the emergency state to the occupancy lighting operational state in which the one or more other lighting units are selectively energized responsive to one or more presence signals from the one or more presence sensors.

10. A lighting system comprising:
one or more light sources;
a presence sensor; and
a controller communicatively coupled with the one or more light sources and the presence sensor, the controller configured to:
enter, on occurrence of a power up event, a first operational state in which the controller energizes the one or more light sources to emit light having a fixed lighting property;
receive, from the presence sensor, a presence signal indicative of detected movement; and
transition, in response to the presence signal, from the first operational state to a second operational state in which the controller selectively energizes the one or more light sources to emit light having varying lighting properties.

11. The lighting system of claim 10, wherein the controller and the one or more light sources are integral in a lighting unit.

12. The lighting system of claim 11, wherein the lighting unit further includes the presence sensor.

13. The lighting system of claim 10, further comprising a network communication interface.

14. The lighting system of claim 13, wherein the controller is further configured to receive, through the network communication interface from one or more other lighting units, one or more signals indicative of movement sensed by presence sensors associated with the one or more other lighting units.

15. The lighting system of claim 10, wherein the one or more light sources are coupled with an emergency power source and an additional, non-emergency power source.

16. The lighting system of claim 15, wherein the presence sensor is coupled solely with the non-emergency power source.

17. The lighting system of claim 10, wherein the first operational state comprises an emergency lighting state.

18. The lighting system of claim 17, wherein the fixed lighting property comprises a brightness or intensity level commensurate with task lighting.

19. The lighting system of claim 10, wherein the second operational state comprises an occupancy lighting operational state, and wherein the controller, when in the occupancy lighting operational state, is further configured to selectively energize the one or more light sources based on one or more signals from the presence sensor.

20. A luminaire, comprising:
one or more sockets for receiving one or more lighting units; and
a controller communicatively coupled with the one or more sockets, the controller configured to:
enter, on occurrence of a power up event, an emergency operational state in which the controller provides a fixed amount of power to the one or more sockets;
receive, from one or more presence sensors, a signal indicative of detected movement; and
transition, in response to the signal, from the emergency operational state to an occupancy lighting operational state in which the controller selectively provides variable amounts of power to the one or more sockets based on one or more additional signals indicative of detected movement from the one or more presence sensors.
